(19) United States
(12) Patent Application Publication
(10) Pub. No.: US 2010/0209055 A1
(43) Pub. Date: Aug. 19, 2010

(54) APPARATUS FOR SPLICING OF OPTICAL WAVEGUIDES

(76) Inventor: Christian Heidler, Hohenschaeftlarn (DE)

Correspondence Address: CORNING INCORPORATED, INTELLECTUAL PROPERTY DEPARTMENT, SP-TI-3-1, CORNING, NY, 14831, US

(21) Appl. No.: 12/704,098

(22) Filed: Feb. 11, 2010

(30) Foreign Application Priority Data
Feb. 13, 2009 (DE) 202009002113.0

(51) Int. Cl. G02B 6/255

(52) U.S. Cl. 385/95

(57) ABSTRACT

An apparatus for splicing of optical waveguides including a control signal generating device for producing a control signal, a control device for providing a nominal level for the control signal, and a heating device for producing heat for heating the optical waveguides. The heating device being controlled by a level of the control signal which is dependent on the nominal level for the control signal and the heating device being designed such that a heating power of the heat is produced as a function of the level of the control signal. The control device detects any discrepancy between the nominal level for the control signal and the level of the control signal, and the control device changes the nominal level for the control signal as a function of the discrepancy found, thereby adapting the control signal as the electrodes are used.

### RELATED APPLICATIONS

This application claims the benefit of German Application No. 20200902113.0 filed Feb. 13, 2009, the entire contents of which are hereby incorporated by reference.

### BACKGROUND

The disclosure relates to an apparatus for splicing of optical waveguides, in which the optical waveguides are heated by a heating device during a splicing process.

Optical waveguides are spliced using splicing apparatuses in which the optical waveguides are heated at their ends to be spliced and are brought into contact with one another, as a result of which the materials of the two optical waveguides melt in the contact area. By way of example, the optical waveguides can be heated by means of an arc. In an embodiment of a splicing apparatus such as this, the heating device may comprise electrodes between which the arc is ignited in order to heat the optical waveguides.

The quality of a splice can be determined, for example, by a splice attenuation that occurs at the splice point. The splice attenuation is dependent inter alia on the heating process for heating the optical waveguides. In the case of a splicer in which the optical waveguides are heated by means of an arc, the splice attenuation can be influenced by the quality of the electrodes. If, for example, the electrodes are dirty or damaged, the shape of the arc ignited between the electrodes changes. The optical waveguides are then, for example, no longer heated uniformly and/or the temperature of the arc no longer corresponds to a nominal value at which the optical waveguides should be spliced.

It is desirable to specify an apparatus for splicing of optical waveguides in which the state of the heating device can be determined in a simple manner in order to heat the optical waveguides in a manner which is favorable for splicing.

### SUMMARY

An embodiment of an apparatus for splicing of optical waveguides comprises a control signal generating device for producing a control signal, a control device for providing a nominal level for the control signal and a heating device for producing heat for heating the optical waveguides. The heating device is controlled by a level of the control signal which is dependent on the nominal level for the control signal. The heating device is furthermore designed such that a heating power of the heat is produced as a function of the level of the control signal. The control device detects any discrepancy between the nominal level for the control signal and the level of the control signal. The control device changes the nominal level for the control signal as a function of the discrepancy found.

According to a further embodiment, the control device provides a first nominal level for the control signal when the discrepancy found is less than a threshold value. The control device provides a second nominal level, which is different from the first nominal level, for the control signal when the discrepancy found is greater than the threshold value. The first nominal level for the control signal is less than the second nominal level for the control signal.

According to a development, the apparatus for splicing the optical waveguides emits a signal when the discrepancy between the nominal level for the control signal and the level of the control signal is greater than the threshold value. For example, the apparatus may comprise an indicating device for indicating control parameters for controlling a splicing process using the apparatus for splicing the optical waveguides. The signal is emitted on the indicating device.

According to a further embodiment of the apparatus, the control device provides the nominal level for the control signal as a function of an air pressure and/or an air temperature.

According to a development of the apparatus for splicing the optical waveguides, the heating device comprises electrodes. The heating device produces the heating power at a level which is suitable for splicing the optical waveguides when the discrepancy found between the nominal level for the control signal and the level of the control signal is less than the threshold value. The heating device produces the heating power at a level which is suitable for cleaning the electrodes of the heating device when the discrepancy found between the nominal level for the control signal and the level of the control signal is greater than the threshold value.

According to a further embodiment, the apparatus for splicing the optical waveguides comprises a comparison device for producing an actuating signal. The comparison device produces a level of the actuating signal as a function of the nominal level for the control signal and the level of the control signal produced. The level of the control signal is dependent on the level of the actuating signal.

According to a further embodiment of the apparatus for splicing the optical waveguides, the control device has an input signal generating circuit for producing an input signal. The input signal generating circuit produces a level of the input signal as a function of the nominal level for the control signal.

In a further embodiment of the apparatus for splicing the optical waveguides, a measurement device is provided for determining the level of the control signal. The measurement device produces a further input signal at a level as a function of the determined level of the control signal.

According to a further embodiment of the apparatus for splicing the optical waveguides, the comparison device compares the level of the input signal with the level of the further input signal, and produces the level of the actuating signal as a function of the comparison between the level of the input signal and the level of the further input signal. The control device may be designed such that the control device determines any discrepancy between the level of the input signal and the level of the further input signal. The control device can furthermore produce the level of the input signal as a function of the determined discrepancy between the level of the input signal and the level of the further input signal.

According to a further embodiment of the apparatus for splicing the optical waveguides, the control signal generating device is connected to the heating device. The control signal generating device produces a control voltage as a function of the level of the input signal. The heating device is controlled by a control current and the level of the control current is dependent on the control voltage. The power of an arc which is ignited between the electrodes is controlled by the heating device as a function of a level of the control current.

According to a further embodiment of the apparatus for splicing the optical waveguides, the control device provides a nominal level for the control current. The control current for splicing of one of the optical waveguides and a further one of the optical waveguides is produced at a level of more than 20 mA when the discrepancy between the nominal level for the control current and the level of the control current is greater than the threshold value. The control current for splicing the optical waveguides can be produced at a level of less than 20 mA when the discrepancy between the nominal level for the control current and the level of the control current is less than the threshold value. The threshold value of the discrepancy between the nominal level for the control current and the level of the control current may, for example, be greater than 20%.

According to a further embodiment of the apparatus for splicing the optical waveguides, the control device finds the discrepancy between the nominal level for the control current and the level of the control current when the control current has been produced by the control signal generating device for a time period of more than 200 ms.

A method for splicing of optical waveguides will be specified in the following text. The method envisages the provision of a heating device for producing heat for splicing of the optical waveguides, with the heat that is produced being dependent on a level of a control signal which controls the heating device. A nominal level for the control signal is provided. The control signal is produced. A heating device is controlled by a level of the control signal which is produced. Any discrepancy between the nominal level for the control signal and the level of the control signal is detected. The nominal level is changed as a function of the discrepancy found.

According to a further embodiment of the method for splicing the optical waveguides, a first nominal level is provided for the control signal when the discrepancy found is less than a threshold value. A second nominal level, which is different from the first nominal level, is provided for the control signal when the discrepancy found is greater than the threshold value. The first nominal level for the control signal may be provided such that it is less than the second nominal level for the control signal.

According to a further embodiment of the method, a signal is emitted when the discrepancy between the nominal level for the control signal and the level of the control signal is greater than the threshold value.

A further embodiment of the method provides that the nominal level for the control signal is provided as a function of an air pressure and/or an air temperature.

According to a further embodiment of the method, the provision of the heating device is provided using electrodes. The heating power is produced by a level which is suitable for splicing of the optical waveguides when the discrepancy found between the nominal level for the control signal and the level of the control signal is less than the threshold value. The heating power is produced by a level which is suitable for cleaning the electrodes of the heating device when the discrepancy found between the nominal level for the control signal and the level of the control signal is greater than the threshold value.

According to a further embodiment of the method, the heating device is provided such that the heat that is produced is dependent on a level of a control current which controls the heating device. The nominal level for the control signal is provided as the nominal level for the control current. The control current is produced. The heating device is controlled by a level of the control current. Any discrepancy between the nominal level for the control current and the level of the control current is detected. The control current for splicing one of the optical waveguides and a further one of the optical waveguides is produced at a level of more than 20 mA when a discrepancy between the nominal level for the control current and the level of the control current is greater than the threshold value. The control current for splicing the optical waveguides can be produced at a level of less than 20 mA when the discrepancy between the nominal level for the control current and the level of the control current is less than the threshold value. The threshold value of the discrepancy between the nominal level for the control current and the level of the control current may, for example, be greater than 20%.

According to a further embodiment of the method, the discrepancy between the nominal level for the control current and the level of the control current is detected when the control current has been produced for a time period of more than 200 ms.

### BRIEF DESCRIPTION OF THE DRAWINGS

The concepts will be explained in more detail in the following text with reference to figures which show exemplary embodiments, and in which:

FIG. 1 shows one embodiment of an apparatus for splicing of optical waveguides,

FIG. 2 shows one embodiment of a splicing device for splicing of optical waveguides,

FIG. 3A shows a discrepancy between an actual level and a nominal level for a control current in one state of the heating device,

FIG. 3B shows a discrepancy between an actual level and a nominal level for a control current in a further state of the heating device,

FIG. 4 shows one embodiment of a splicing device for determining a state of a heating device, and

FIG. 5 shows one embodiment of a control device for controlling a heating device for heating of optical waveguides.

### DETAILED DESCRIPTION

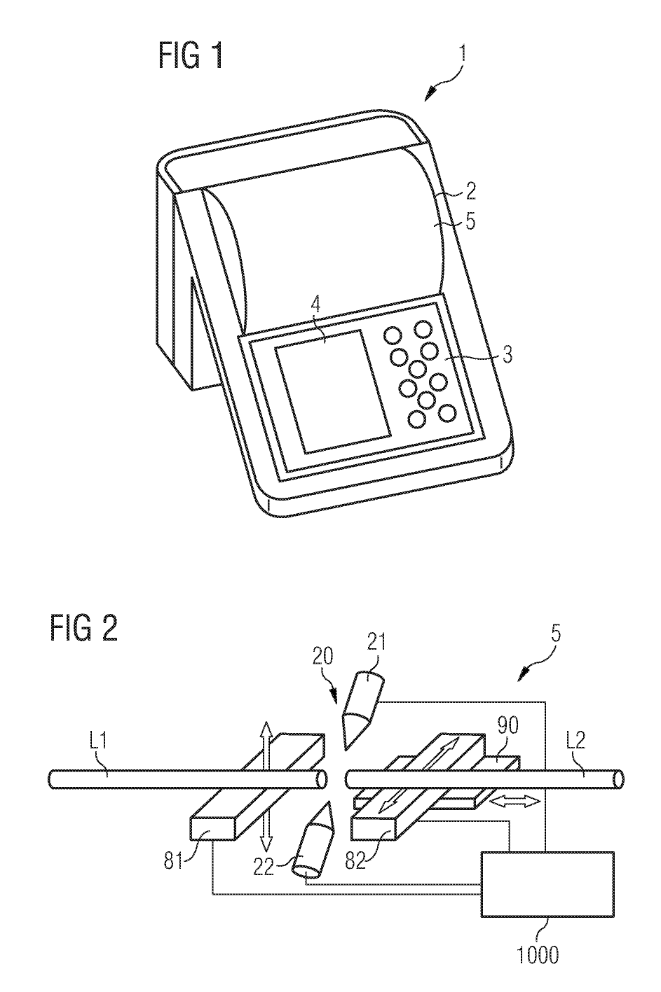

FIG. 1 shows an embodiment of an apparatus 1 for splicing of optical waveguides, in which a splicing device 5 is arranged under a cover 2. The cover 2 protects the splicing device 5 against damage to its components, and at the same time against dirt. A control panel 3 is provided in order to control the apparatus 1. Control parameters, which allow a splicing process to be controlled, can be entered via the control panel 3. The entered parameters are indicated on an indicating device 4. Furthermore, the indicating device 4 can be used to output further operating parameters which relate to the splicing apparatus, as well as parameters which identify the state of the optical waveguides before, during and after a splicing process.

FIG. 2 shows an embodiment of the splicing device 5 for splicing of optical waveguides L1 and L2, arranged under the cover 2. The splicing device comprises a heating device 20 with electrodes 21 and 22, between which an arc is ignited in order to heat the optical waveguides L1 and L2. Various holding devices are provided in order to align the optical waveguides to be spliced. The splicing device 1 has a holding device 81 in order to hold the optical waveguide L1. By way of example, the holding device 81 can be used to move the optical waveguide L1 in a vertical direction with respect to the longitudinal direction of the optical waveguide. A holding device 82 is provided in order to align the optical waveguide L2 with the optical waveguide L1. The optical waveguide L2 can be moved on a horizontal plane transversely with respect to the longitudinal direction of the optical waveguide L2 by moving the holding device 82. In order to move the optical waveguide L1 in the direction of the optical waveguide L2, the holding device 82 is arranged on a movement device 90. The movement device 90 allows the optical waveguide L2 to be moved in the longitudinal direction, and thus towards the optical waveguide L1.

A control unit 1000 is used to control the movements of the holding devices and of the movement device, and to control the heating device. The control unit 1000 controls the electrodes 21 and 22 by means of a control signal, for example a control current, in order to control the power with which the arc is produced. The heating power of the heating device can thus be adjusted as a function of a level of the control signal, by varying the energy of the arc. This also results in the temperature to which the optical waveguides are heated being controlled as a function of the level of the control signal.

The nominal level of the control signal which is used to control the heating device 20 is adjusted by the control unit as a function of the type of fibres to be spliced and as a function of external climatic conditions. If, for example, a control current is used for control purposes, then the nominal level for the control current can be preset by the control unit 1000, for example by the control unit applying a control voltage to a circuit between the electrodes. This results in a control current level being set in the circuit between the electrodes. The level of this control current is dependent on the level of the control voltage and, furthermore, on the state of the electrodes.

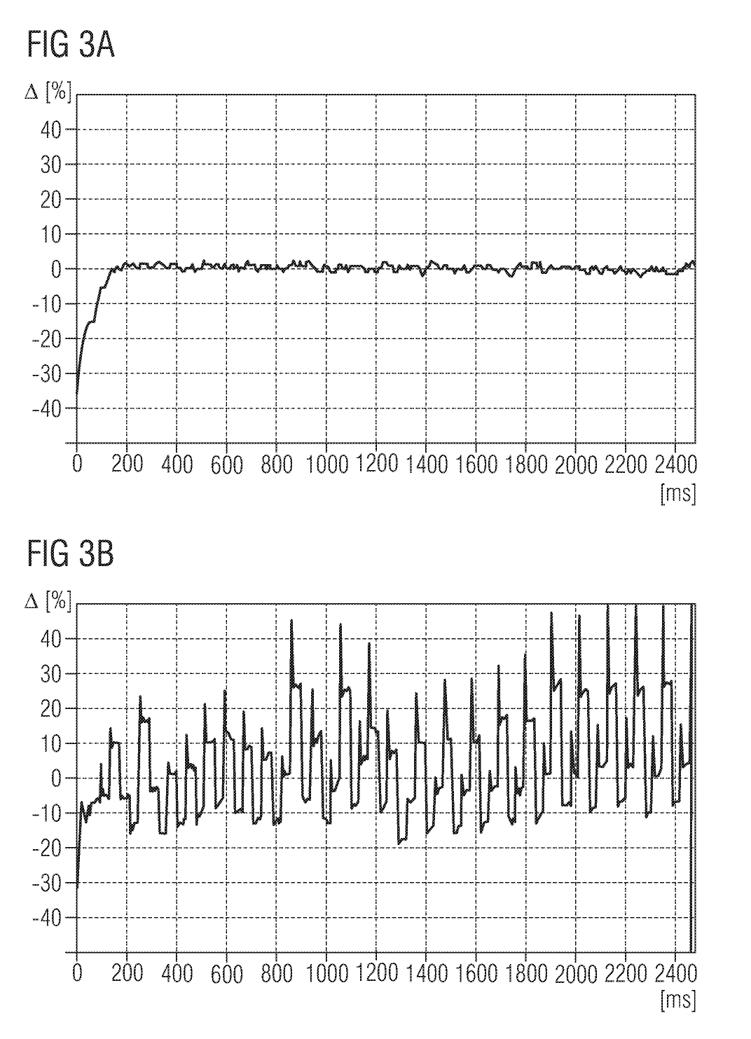

The diagrams illustrated in FIGS. 3A and 3B show a percentage discrepancy Δ between the control current flowing in the circuit between the electrodes and a nominal level for the control current during a time period from 0 to 2400 ms.

In the diagram shown in FIG. 3A, the level of the control current has only minor discrepancies from the nominal level for the control current. The current profile of the control current shown in FIG. 3A can be detected when using cleaned electrodes. If the electrode quality is high, and this is dependent on the shape of the electrodes, in particular of the electrode tips, as well as the cleanliness of the electrodes, the actually measured control current corresponds approximately to the nominal level of the control current.

FIG. 3B shows a control current measured in the electrode circuit when using electrodes which are dirty in comparison to the electrodes which were used for the measurement shown in FIG. 3A. There is a considerable discrepancy between the determined level of the control current and the nominal level for the control current. The greater fluctuations between the nominal level and the actual level of the control current are caused essentially by the dirt on the electrodes, to be precise deposits on the electrode tips, which change the shape of the electrodes.

The two diagrams clearly show that there is a correlation between the dirt on the electrodes and the discrepancy between the nominal level and actual level of the control current, and this correlation can be used to obtain information that, although the heating device is possibly still heating the optical waveguides, the heating in the optical waveguides is, however, not achieved during the heating process, as a result of which increased splice attenuation can be expected at a splice point between the optical waveguides.

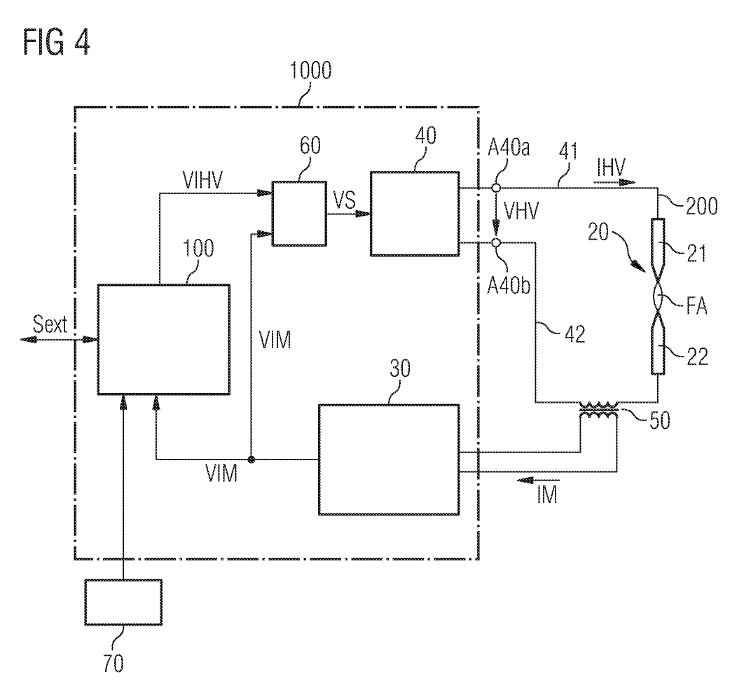

FIG. 4 shows an embodiment of the control unit 1000 for producing a control signal IHV which is supplied to the heating device 20. For this purpose, the control unit 1000 is connected via conductor tracks 41 and 42 to the heating device 20. The heating power of the heat produced by the heating device 20 is adjusted as a function of the level of the control signal IHV. In the embodiment shown in FIG. 4, the heating device 20 comprises electrodes 21 and 22, between which an arc FA is ignited in order to heat optical waveguides.

The control unit 1000 is connected to the heating device 20 via a circuit 200 which comprises the conductor track 41, the electrode 21, the arc gap FA, the electrode 22 and the conductor track 42. The control unit 1000 produces a control voltage VHV on the output side between connections A40a and A40b, and this control voltage VHV produces the control signal IHV in the circuit 200. When using a heating device in which the heat is created by igniting an arc, the heat that is produced is dependent on the energy of the arc which is ignited between the electrodes. The control signal IHV may, for example, be a control current which occurs in the electrode circuit 200 after the arc has been ignited.

The control unit 1000 comprises a control device 100, a measurement device 30, a comparison device 60 and a control signal generating device 40. The control signal generating device 40 may be in the form of a voltage generator. The voltage generator 40 produces the control voltage VHV between the connections A40a and A40b. The control voltage VHV that is produced results in the control current IHV occurring in the electrode circuit 200. The level of the control current IHV is dependent inter alia on the level of the control voltage VHV.

Furthermore, the level of the control current IHV is governed by the resistance in the electrode circuit. The resistance in the electrode circuit is influenced in particular by the state of the heating device 20. For example, if the tips of the electrodes 21 and 22 are dirty, the resistance is higher than if the arc were to be produced between clean electrodes. The state of the electrodes, in particular the amount of dirt on them, becomes poorer as the number of splicing processes increases, as a result of which a different control current IHV flows in the electrode circuit, despite the control voltage VHV being constant.

The measurement device 30 is provided in order to determine the level of the control current IHV flowing in the electrode circuit 200. A portion IM of the electrode current flowing in the electrode circuit is output from the electrode circuit by means of a transmission element 50, for example a transformer, one winding of which is connected to the conductor track 42. The partial current IM output from the electrode circuit is supplied to the measurement device 30. The use of the transmission element 50 ensures that the measurement device 30 is not supplied with the entire very high control current IHV which occurs after the arc has been ignited in the electrode circuit.

The measurement device 30 determines the level of the partial current IM and produces a signal VIM on the output side. The level of the signal VIM is produced by the measurement device 30 as a function of the determined level of the partial current IM. In order to produce the signal VIM, the measurement device 30 may, for example, contain a current/voltage converter, as a result of which a voltage is produced on the output side of the measurement device 30 as a function of the determined level of the partial current IM, and this is provided as the signal VIM. The level of the signal VIM is therefore a measurement of the actual level of the control current IHV in the electrode circuit 200.

The signal VIM is supplied as an input signal to the comparison device 60. The comparison device 60 has an input signal VIHV applied to it in addition to the input signal VIM. The input signal VIHV is produced by the control device 100. By way of example, the input signal VIHV may be an input voltage. A level of the input signal VIHV 15 dependent on the nominal level at which the control current IHV is intended to be supplied to the heating device in the electrode circuit in order to ensure correct heating of the optical waveguides for a splicing process.

The level of the input signal VIHV, which represents the nominal level of the control signal IHV, is compared in the comparison device 60 with the level of the input signal VIM, which indicates the actual level of the control signal IHV. Depending on the comparison, to be precise the discrepancy between the two levels, the comparison device 60 produces a level of an actuating signal VS. The actuating signal VS is supplied to the control signal generating device 40. The control signal generating device 40 produces the level of the control voltage VHV, and therefore also produces the control signal IHV, as a function of the level of the actuating signal VS.

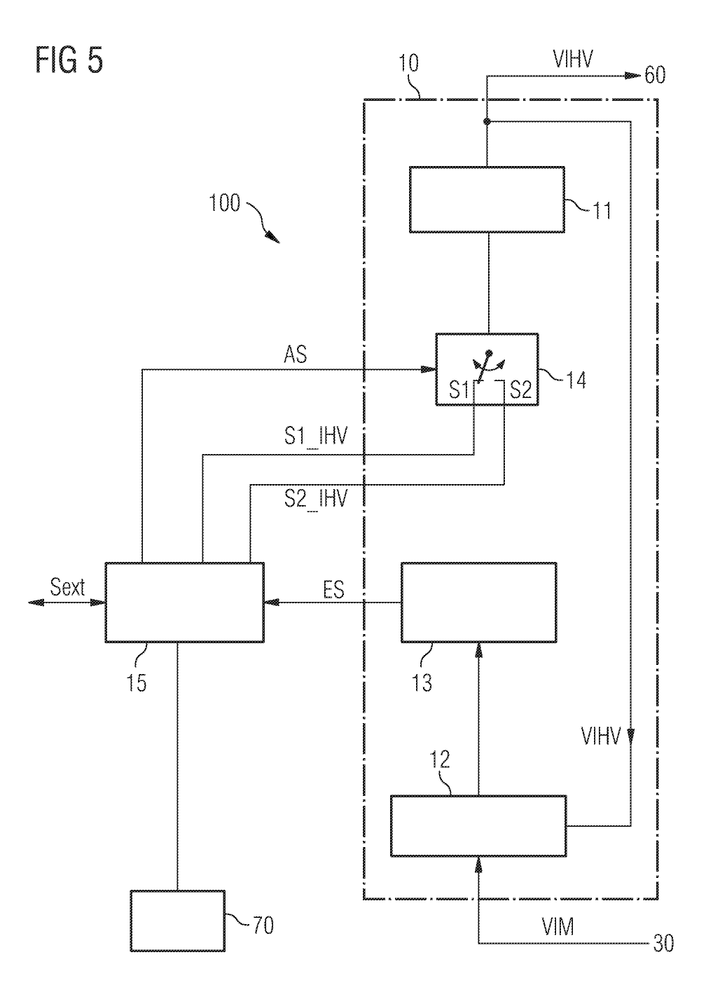

The input signal VIM produced by the measurement device 30 is also passed to the control device 100 in order to provide the nominal level of the control signal IHV. FIG. 5 shows an embodiment of the control device 100. The control device 100 may comprise a control circuit 10 which produces the input signal VIHV on the output side.

The control circuit 10 comprises an evaluation circuit 12, a decision-maker circuit 13, a controllable switching unit 14 and an input signal generating circuit 11. The circuit units 11, 12, 13 and 14 may be in the form of discrete circuits. As an alternative to this, the control circuit 10 may be in the form of a control processor which carries out the function of the circuit units 11, 12, 13 and 14.

The method of operation of the control device 100 will be explained in the following text. After the splicing apparatus has been switched on, a superordinate main control circuit 15, which is provided for example as a main processor for the splicing apparatus, controls the controllable switching unit 14 by an activation signal AS such that a controllable switch in the switching unit 14 is set to the switch position 51. In the switch position 51, the controllable switching unit is provided by the main control circuit with a nominal level S1_IHV which indicates a nominal level for the control current IHV, which should be applied to the heating device 20 for splicing of optical waveguides.

In the switch position 51, the controllable switching unit 14 therefore provides a nominal level S1_IHV for the control current IHV, which is passed to the input signal generating circuit 11. On the output side, the input signal generating circuit 11 produces a level, for example a voltage level, of the input signal VIHV as a function of the nominal level S1_IHV of the control current IHV. The control signal generating device 40 then produces the control voltage VHV, which causes the control current IHV to flow in the electrode circuit 200. The control current which is actually caused in the electrode circuit is determined by the measurement device 30. The measurement device 30 for this purpose determines the partial current IM which is output from the electrode circuit, and produces the input signal VIM as a function of the measured partial current.

By way of example, the input signal VIM may be an input voltage which is supplied to the evaluation circuit 12 of the control device 100. The evaluation circuit 12 is also supplied with the input signal VIHV. The evaluation circuit 12 compares the two signal levels, for example by forming a difference between the two signal levels. The magnitude of the difference is compared with a threshold value in the decision-maker circuit 13. Different levels of a comparison signal ES are applied to the main control circuit 15 depending on the comparison result. For example, the comparison signal ES assumes a low level when the magnitude of the difference is less than the threshold value, and a high level when the magnitude of the difference is greater than the threshold value. By way of example, the threshold value may be 20%. When the input signals VIHV and VIM are voltages, the threshold value is, for example, set to a value which is greater than 10 mV.

When the magnitude of the difference is below the threshold value, the controllable switch in the controllable switching unit 14 is not changed by the main processor 15. The control circuit 10 therefore still presets the nominal level S1_IHV and, on the output side, produces the input signal VIHV, which indicates the nominal level of the control current during splicing operation for splicing of optical waveguides. The nominal level of the control current can be preset by the control device 100 to a level of less than 20 mA, for example to a level between 10 mA and 16 mA. The control loop which comprises the comparison device 60, the control signal generating device 40 and the measurement device 30 is used to match the control current IHV in the electrode circuit 200 to the preset nominal level S1_IHV of the control current for splicing operation, provided that the discrepancy between the signal levels of the input voltages VIHV and VIM is less than the threshold value, for example less than 10 mV.

When the electrodes become dirty as the number of splicing processes increases, the resistance in the electrode circuit 200 increases. The control voltage is readjusted by the control signal generating device 40 by means of the closed-loop control until the control current IHV no longer reaches the nominal level, because the electrodes are becoming increasingly dirty.

The level of the input signal VIM, which indicates the actual level of the control current IHV in the electrode circuit, therefore deviates increasingly from the level of the input signal VIHV by means of which the nominal level is preset for the control current. The evaluation circuit 12 determines the magnitude of the discrepancy between the respective levels of the input signals VIHV and VIM. The value of the difference between the signal levels is supplied to the decision-maker circuit 13. The decision-maker circuit 13 compares the determined discrepancy between the signal level of the input signal VIHV and the signal level of the input signal VIM with the threshold value. Since the magnitude of the difference between the two signal levels is above the threshold value when the electrodes are very dirty, for example more than 10 mV, a high level of the comparison signal ES is applied to the main processor 15.

The main processor then applies a different level of the control signal AS to the controllable switching unit 14, as a result of which the controllable switch is moved to the switch position S2. In the switch position S2, the main control circuit 15 provides a different nominal level S2_IHV of the control current. The nominal level S2_IHV is higher than the nominal level S1_IHV which is provided for splicing of optical waveguides. For example, the nominal level S2_IHV is more than 20 mA. For example, the nominal level may be 25 mA. Corresponding to the different nominal level for the control current, the input signal generating circuit 11 produces a different level of the input signal VIHV. The closed-loop control by means of the control loop results in the control signal generating device 40 producing the control voltage VHV at a higher level, as a result of which the control current in the electrode circuit rises.

In the operating state, in the switch position S2 of the controllable switching unit, the control current IHV is produced at a level by means of which the heating power of the heat produced by the heating device, to be precise the energy of the arc, is increased in such a manner that any dirt on the electrodes is removed by a higher arc energy and thus by an increased arc temperature. The increased heating power of the arc burns off the dirt particles on the electrode tips, and thus cleans the electrodes.

For this purpose, the controllable switch in the controllable switching unit 14 remains in the switch position S2 for a time period of approximately 10 s to 20 s, for example, as a result of which the control current IHV is produced at a level of more than 20 mA. A current such as this is particularly suitable for cleaning of electrodes which are provided for splicing of individual optical waveguides. Once the time period has elapsed, the main processor 15 applies a changed state of the activation signal AS to the controllable switching unit 14, as a result of which the controllable switch in the controllable switching unit is reset to the switch position 51. The main control circuit 15 therefore once again provides the nominal level S1_IHV as the nominal level of the control current, for the control current for splicing of optical waveguides.

The nominal level of the control current, in particular the nominal level S1_IHV of the control current which is provided by the control device 100 for splicing of optical waveguides, is a function of the fiber type of the optical waveguides to be spliced and of the climatic environmental conditions in which the splicing process is carried out. In order to provide the nominal level of the control current IHV, the control device 100 may be connected to a device 70 for detection of parameters which indicate the climatic conditions in which the splicing apparatus is being operated. For example, the device 70 can determine a temperature or an air pressure in the vicinity of the splicing apparatus. The control device 100 can use the determined climatic parameters in the vicinity of the splicing apparatus to determine the nominal level S1_IHV of the control current for a splicing process. The nominal level can also be preset by a user as an external nominal value Sext, by means of the control panel 4 on the splicing apparatus. An interface, for example a bidirectional interface, can be provided on the main processor, for communication.

Since, in order to ignite the arc to perform a splicing process, the control signal generating device 40 first of all produces a high control voltage VHV which is higher than the control voltage which is produced in the subsequent splicing operation, an increased control current IHV occurs in the electrode circuit immediately after the arc has initially been ignited. This igniting current level of the control current may, for example, be 20 mA. The control signal generating device 40 reduces the control voltage VHV only after a time period has elapsed, for example after 200 ms, as a result of which the control current IHV falls to a level range which is used for operation of the heating apparatus for the splicing of optical waveguides during continuous operation of the splicing apparatus. The continuous current level at which the optical waveguides are heated by the arc for splicing is, for example, 10 mA. Any discrepancy between the nominal level and actual level of the control current IHV is evaluated by the control device 100 only when the control current IHV is set to the continuous current level in the electrode circuit. The control device is designed such that the discrepancy between the determined actual level of the control current and the nominal level is therefore evaluated only after a delay time of, for example, 200 ms. For example, the control device may contain a timing circuit, so that the evaluation of the discrepancy between the nominal level and the determined actual level of the control current, or the discrepancy between the signal levels of the input signals VIHV and VIM and/or the comparison of the discrepancy between the signal levels and the threshold value are/is carried out only after the delay time has elapsed.

In another embodiment of the control device 100, a warning signal is emitted on the indicating device 4 when the discrepancy between the actual level and the nominal level for the control current is greater than the threshold value. For example, an appropriate indication of the indicating device can be used to request a user to manually clean the electrodes or to remove them and to replace them by new intact electrodes. Depending on the determined discrepancy between the nominal level and the actual level of the control current IHV, an indication can be produced, for example, as to how many splicing operations can still be carried out with the electrodes in the splicer before the quality of the spliced joints that are produced has deteriorated to such an extent that the electrodes must be cleaned or replaced because of the increased splice attenuation to be expected.

The embodiments, as illustrated in FIGS. 1, 2, 4 and 5, of the apparatus for splicing of optical waveguides allow the instantaneous state of the heating device to be determined by determining and evaluating the discrepancy between the actual level and nominal level of the control current. In particular, dirt on or damage to electrodes of the heating device can be deduced when there is an increased discrepancy between the determined actual level and the nominal level of the control current. For example, if the discrepancy between the nominal level and the actual level of the control current is greater than 20%, it can be assumed that the electrodes are very dirty. In this case, the control signal generating device produces a high control voltage. The high control voltage applied to the electrodes results in an arc being ignited even when the electrodes are very dirty. The electrodes are cleaned by the high control current which occurs in the electrode circuit. Furthermore, it is possible to emit a warning signal in order to request a user to replace the electrodes, when the discrepancy between the nominal level and the actual level of the control current is, for example, greater than a threshold value of more than 20%.

We claim:

1. An apparatus for splicing of optical waveguides, comprising:
a control signal generating device for producing a control signal;
a control device for providing a nominal level for the control signal;
a heating device for producing heat for heating the optical waveguides, with the heating device being controlled by a level of the control signal which is dependent on the nominal level for the control signal and the heating device being designed such that a heating power of the heat is produced as a function of the level of the control signal; and
wherein, the control device detecting any discrepancy between the nominal level for the control signal and the level of the control signal, and the control device changing the nominal level for the control signal as a function of the discrepancy found.

2. The apparatus of claim 1, the control device providing a first nominal level for the control signal when the discrepancy found is less than a threshold value, and the control device providing a second nominal level, which is different from the first nominal level for the control signal when the discrepancy found is greater than the threshold value.

3. The apparatus of claim 2, the first nominal level for the control signal being less than the second nominal level for the control signal.

4. The apparatus of claim 1, the apparatus for splicing the optical waveguides emitting a signal when the discrepancy between the nominal level for the control signal and the level of the control signal is greater than the threshold value.

5. The apparatus of claim 4, further comprising:
an indicating device for indicating control parameters for controlling a splicing process using the apparatus for splicing the optical waveguides with the signal being emitted on the indicating device.

6. The apparatus of claim 1, the control device providing the nominal level for the control signal as a function of an air pressure and/or an air temperature.

7. The apparatus of claim 1, wherein the heating device includes electrodes and the heating device producing the heating power at a level which is suitable for splicing the optical waveguides when the discrepancy found between the nominal level for the control signal and the level of the control signal is less than the threshold value, and wherein the heating device producing the heating power at a level which is suitable for cleaning the electrodes of the heating device when the discrepancy found between the nominal level for the control signal and the level of the control signal is greater than the threshold value.

8. The apparatus of claim 1, further comprising:
a comparison device for producing an actuating signal, with the comparison device producing a level of the actuating signal as a function of the nominal level for the control signal and the level of the control signal produced.

9. The apparatus of claim 1, the level of the control signal being dependent on the level of the actuating signal.

10. The apparatus of claim 1, the control device having an input signal generating circuit for producing an input signal, and the input signal generating circuit producing a level of the input signal as a function of the nominal level for the control signal.

11. The apparatus of claim 1, further comprising:
a measurement device for determining the level of the control signal (IHV), wherein the measurement device producing a further input signal at a level as a function of the determined level of the control signal.

12. The apparatus of claim 1, the comparison device comparing the level of the input signal with the level of the further input signal, and producing the level of the actuating signal as a function of the comparison between the level of the input signal and the level of the further input signal.

13. The apparatus of claim 11, the control device being designed such that the control unit determines any discrepancy between the level of the input signal and the level of the further input signal.

14. The apparatus of claim 11, the control device producing the level of the input signal as a function of the determined discrepancy between the level of the input signal and the level of the further input signal.

15. The apparatus of claim 7, the control signal generating device being connected to the heating device, the control signal generating device producing a control voltage as a function of the level of the input signal, with the heating device being controlled by a control current and the level of the control current being dependent on the control voltage, and the power of an arc which is ignited between the electrodes being controlled by the heating device as a function of a level of the control current.

16. The apparatus of claim 15, the control device providing a nominal level for the control current, and the control current being produced at a level of more than 20 mA for splicing of one of the optical waveguides and a further one of the optical waveguides when the discrepancy between the nominal level for the control current and the level of the control current is greater than the threshold value.

17. The apparatus of claim 16, the control current for splicing the optical waveguides being produced at a level of less than 20 mA when the discrepancy between the nominal level for the control current and the level of the control current is less than the threshold value.

18. The apparatus of claim 2, the threshold value of the discrepancy between the nominal level for the control current and the level of the control current being greater than 20%.

19. The apparatus of claim 16, the control device detecting the discrepancy between the nominal level for the control current and the level of the control current when the control current has been produced by the control signal generating device for a time period of more than 200 ms.
